(19) United States
(12) Patent Application Publication
(10) Pub. No.: US 2018/0215077 A1
(43) Pub. Date: Aug. 2, 2018

(54) Shell Mold

(71) Applicant: NIKE, Inc., Beaverton, OR (US)

(72) Inventor: Jose Isse, Beaverton, OR (US)

(21) Appl. No.: 15/879,247

(22) Filed: Jan. 24, 2018

Related U.S. Application Data
(60) Provisional application No. 62/451,498, filed on Jan. 27, 2017.

(51) Int. Cl. B29C 33/38; B33Y 10/00; B33Y 80/00

(52) U.S. Cl. CPC B29C 33/3842; B29D 35/122; B33Y 80/00; B33Y 10/00

(57) ABSTRACT

A multi-part mold formed from a shell mold and a mold base provides efficiency in a manufacturing process. The shell mold may be formed on a positive mold article. The positive mold article may be formed from a rapid manufacturing process. The shell mold may then be formed on a surface of the positive mold article through a coating process that builds a relatively thin coating that results in a mold surface for molding an object represented, at least in part, by the positive mold article. The shell mold is then joined with a mold base effective to support the shell mold for the molding operation.

### CROSS-REFERENCE TO RELATED APPLICATIONS

This application having attorney docket number NIKE.288105/16482US02 and entitled “Shell Mold” claims the benefit of U.S. Provisional Application No. 62/451,498, entitled “Shell Mold,” and filed Jan. 27, 2017. The entirety of the aforementioned application is incorporated by reference herein.

### TECHNICAL FIELD

Tooling, such as a mold, is used to manufacture components.

### BACKGROUND

Traditional molds may be expensive, heavy, and have long lead times for manufacturing. Further, a traditional mold may be formed from a material quantity that requires excessive energy to thermally adjust for efficient cycle times and molded-product quality.

### BRIEF SUMMARY

Aspects hereof provide a method of forming a mold. The method includes forming a positive mold article. The positive mold article may be formed from a rapid manufacturing process, such as an additive manufacturing process. The positive mold article serves as a representation of the article to eventually be molded by a shell mold that will be formed on the positive mold article. The method also includes coating at least a portion of the positive mold article with a mold-forming material to form the shell mold. The shell mold is comprised of a molding surface adjacent the positive mold article and a non-molding surface nonadjacent the positive mold article. The shell mold may be formed from any material, such as a metallic-based material, a polymer-based material, or a ceramic-based material. The method also includes detaching the shell mold from the positive mold article. Once detached, the shell mold is joined with a mold base. An internal volume is formed between the non-molding surface and the mold base. The internal volume may be filled with a fill material to provide physical support to the shell mold and/or to assist in thermal conductivity to/from the shell mold.

This summary is provided to enlighten and not limit the scope of methods and systems provided hereafter in complete detail.

### DESCRIPTION OF THE DRAWINGS

The present invention is described in detail herein with reference to the attached drawing figures, wherein:

FIG. 1 depicts a method of forming a mold, in accordance with aspects hereof;

FIG. 2 depicts a positive mold article, in accordance with aspects hereof;

FIG. 3 depicts a cross sectional view of the positive mold article of FIG.2, in accordance with aspects hereof;

FIG. 4 depicts the positive mold article of FIG. 2 having a coating thereon forming a shell mold, in accordance with aspects hereof;

FIG. 5 depicts a cross sectional view of the positive mold article and the shell mold of FIG. 4, in accordance with aspects hereof;

FIG. 6 depicts the shell mold detached from the positive mold article of FIG. 4, in accordance with aspects hereof;

FIG. 7 depicts a cross sectional view of the shell mold of FIG. 6, in accordance with aspects hereof;

FIG. 8 depicts a mold base, in accordance with aspects hereof;

FIG. 9 depicts a cross sectional view of the mold base of FIG. 8, in accordance with aspects hereof;

FIG. 10 depicts the shell mold of FIG. 6 joined with the mold base of FIG. 8 to form a mold, in accordance with aspects hereof;

FIG. 11 depicts a cross sectional view of the mold from FIG. 10, in accordance with aspects hereof;

FIG. 12 depicts a molded component formed by the mold of FIG. 10, in accordance with aspects hereof;

FIG. 13 depicts a cross sectional view of the mold and molded component of FIG. 12, in accordance with aspects hereof; and

FIG. 14 depicts an exemplary system, in accordance with aspects hereof.

### DETAILED DESCRIPTION

The ability to quickly and efficiently generate tooling for manufacturing processes can increase productivity in manufacturing and increase tooling options. Further, an ability to generate a tooling that is formed with assistance of rapid manufacturing techniques provides flexibility to a manufacturing process. Aspects hereof contemplate forming a mold. The mold is formed in an exemplary aspect by forming a positive mold article. The positive mold article may be formed with a rapid manufacturing process. The positive mold article is formed, in part, to represent an object to be molded with the resulting mold. A coating is applied to the positive mold article to form a shell mold on the positive mold article. The shell mold may have a thickness less than 20 millimeters. The shell mold is then detached from the positive mold article and joined with a mold base. The shell mold as supported by the mold base may then be used as a mold.

In the example above, multiple shell molds may be formed efficiently as provided herein. Each of the shell molds may be joined with the mold base allowing for a common mold base to be used in connection with a variety of shell molds. The concept of a universal mold base can further reduce tooling costs, reduce tool storage burdens, and simplify additional tooling in the manufacturing process with a universal mold base.

Aspects hereof contemplate a method of forming a mold that includes forming a positive mold article and coating at least a portion of the positive mold article with a mold-forming material to form a shell mold. The shell mold is comprised of a molding surface that is adjacent the positive mold article and a non-molding surface that is nonadjacent the positive mold article. The method also includes detaching the shell mold from the positive mold article and then joining the shell mold with a mold base. An internal volume is formed between the non-molding surface and the mold base. This internal volume may be filled with a substantially non-compressible material such as an aluminum-based powder. The fill material provides structural support for the shell mold and serves as a conductor of thermal energy, in an exemplary aspect, from a heating element within the internal volume to the shell mold. Aspects also contemplate applying a release agent to the positive mold article prior to forming the shell mold thereon to aid in the detaching of the shell mold from the positive mold article.

Another exemplary aspect hereof contemplates a mold having a mold base with a bottom surface and a plurality of side surfaces extending from the bottom surface. The mold also includes a shell mold having a molding surface and an opposite non-molding surface. The shell mold has a thickness between the molding surface and the non-molding surface within a range of 20 millimeters to 0.5 millimeters. It is contemplated that the shell mold may be formed from a variety of processes, such as electrodeposition, plating, dipping, spraying, and the like. Further, it is contemplated that the shell mold could be formed from a variety of materials, such as a metallic-based material, a ceramic-based material, or a polymer-based material. It is also contemplated that the shell mold is formed from a variety of layers that may have the same or different materials (e.g., a lamination) to achieve a target characteristic (e.g., hardness, ductility, resilience, thermal conductivity, texture) for the shell mold. The shell mold is coupled permanently or temporarily with the mold base proximate the mold base side surfaces. The shell mold and the mold base define an internal volume between the mold base bottom surface, the mold base side surfaces, and the shell mold non-molding surface. The internal volume may be filled with a material that is effective to physically support the shell mold during molding operations. Also the fill material may be effective to conduct thermal energy to the shell mold to assist in a molding operation, in an exemplary aspect.

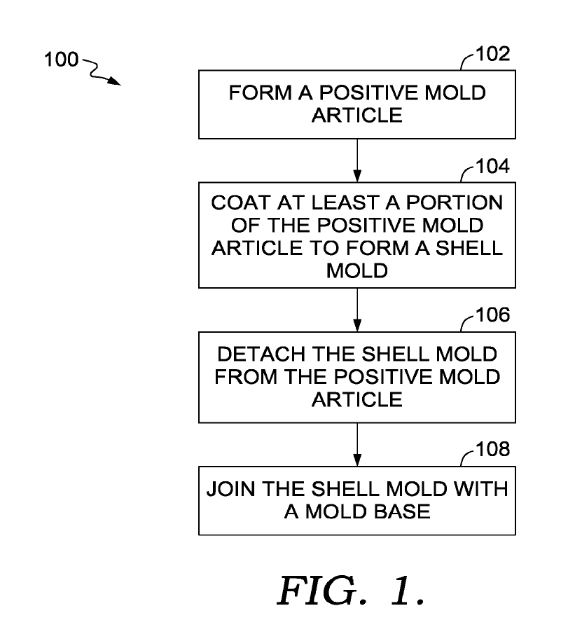

Turning to FIG. 1 that depicts a method 100 of forming a mold, in accordance with aspects hereof. The method 100 includes a block 102 representing forming a positive mold article. The positive mold article is a representation, at least in part, of a component intended to be molded with the mold. For example, if the intended component to be formed is a shoe sole portion, the positive mold article includes a shoe sole portion shape. It is contemplated that the positive mold article may include a representation of any component for any industry. For example, the representation included in the positive mold article may relate to the footwear, automotive, aerospace, medical device, industrial component, and the like industries.

Forming of the positive mold article may be accomplished with a variety of techniques; however, in an exemplary aspect the forming is intended to be accomplished in a relatively fast and relatively precise manner, such as through rapid manufacturing techniques. The rapid manufacturing technique used may vary depending on a variety of factors, such as cost, speed, precision, and the like. However, it is contemplated that the process may be accomplished in either an additive manner and/or in a subtractive manner.

Examples of additive rapid manufacturing include, but are not limited to, fused deposition modeling, fused filament fabrication, direct ink writing, stereo lithography, digital light processing, powdered bed printing, electron beam melting, selective laser melting, selective heat sintering, selective laser sintering, direct metal laser sintering, laminated object manufacturing, and electron beam freeform fabrication, and the like. As these techniques are merely exemplary in nature, it is contemplated that additional techniques may be implemented and this listing is not limiting in nature. Subtractive manufacturing techniques may include traditional machining processes like milling. It is contemplated that computer-numerically-controlled (CNC) machines may be leveraged to form the positive mold article.

Regardless if the positive mold article is formed from a subtractive or an additive process, it is contemplated in an exemplary aspect that a digital model of the positive mold article is formed, such as through computer aided design software or other three-dimensional modeling program. The digital model may be communicated from a computing device having a processor and memory, such as non-transitory computer readable memory, to a rapid manufacturing machine. In turn, the rapid manufacturing machine may convert one or more instructions into steps taken by the machine to form the positive mold article.

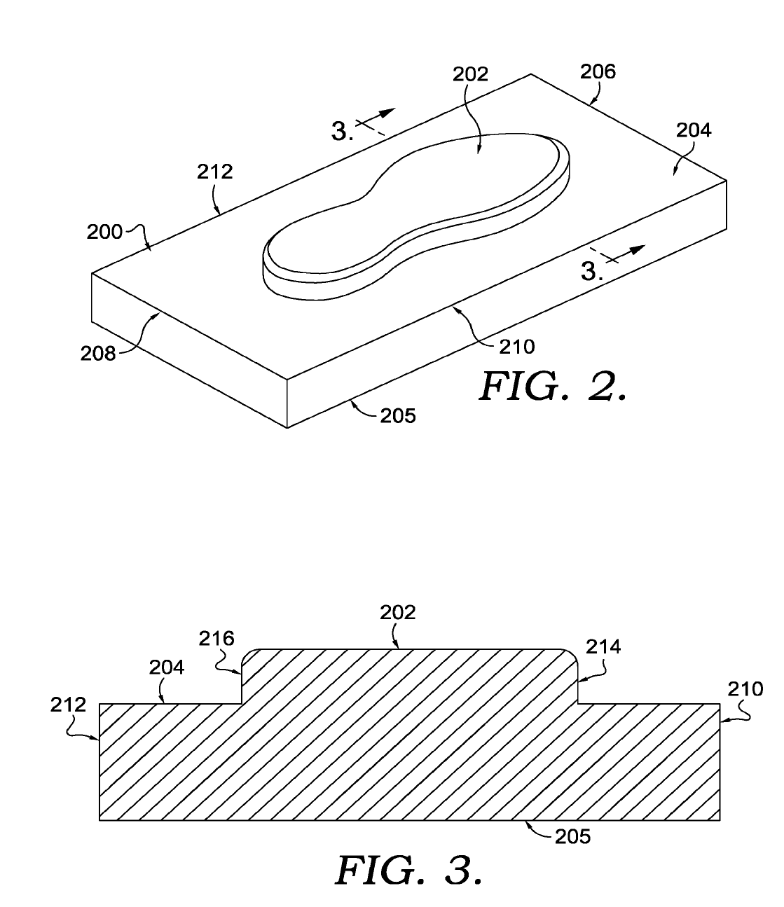

The positive mold article, as depicted in an exemplary manner in FIG. 2, may include both an object representation (e.g., 202 of FIG. 2) and a flange portion (e.g., 204 of FIG. 2). The flange portion may be sized and configured such that a shell mold formed thereon may include a representation of the flange to join with a mold base. Therefore, the positive mold article includes the object representation to be molded and it also includes a flange that is effective to join a resulting shell mold with a mold base. The flange may extend from the object representation such that it forms a perimeter around the object representation. This flange may be substantially planar.

At a block 104, at least a portion of the positive mold article is coated to form a shell mold. The shell mold is a relatively thin (e.g., less than 1 centimeter thick, such as 1-5 millimeters in thickness) mold portion that eventually provides a molding surface against which a mold material is placed to form a molded object in the shape of the object representation on the positive mold article.

Coating of the positive mold article may be accomplished by a number of techniques. In an exemplary aspect, the coating technique implemented results in a shell mold having a thickness between 20 millimeters (mm) and 0.5 mm. This shell mold thickness could also be between 10 mm and 0.5 mm. The shell thickness could also be between 5 mm and 0.5 mm. In an exemplary aspect, the shell thickness is between 3 mm and 2 mm. A thickness of the shell mold is determined based on a number of factors, such as mold longevity, mold strength, mold toughness, mold resilience, mold hardness, and thermal conductivity.

As the thickness of the shell mold decreases, so may the longevity of the mold. However, as the mold thickness increases, the weight, cost, and manufacturing time may also increase. Further, as material thickness forming the shell mold increases, a time to heat and/or cool the shell mold may also increase (e.g., thermal mass), which can result in longer cycle times during manufacturing. Therefore a balance is obtained with a thin enough shell mold to reduce cost and time during use, but substantial enough to provide physical characteristics sufficient to produce the molded component within set tolerances. As will be discussed hereinafter, a fill material providing physical support to the shell mold may be utilized within the mold base to supplement physical characteristics to better obtain cost and time efficiencies of a thinner shell mold.

The coating may be achieved by processes such as electrodeposition, plating, dipping, or spraying. Each process allows for the deposition of a material onto one or more surfaces of the positive mold article. For example, it is contemplated that the positive mold article may be formed from or coated with an electrically conductive material. The positive mold article may then be introduced into an electrodeposition bath that attracts one or more coating materials within the bath to the charged surface of the positive mold article. It is contemplated that the electrical charge may be adjusted by voltage, amperage, pulse rate, and time to alter a deposition characteristic (e.g., amount of material deposited, type of material deposited, density of material deposited). Similarly characteristics of the process (e.g., temperature, rotation speed, bath composition) can also be changed to adjust the deposition characteristics. In an exemplary aspect, it is contemplated that the electrodepositing bath includes a variety of metallic elements that, depending on charge characteristics, deposit on the positive mold article. Therefore, a layering of different metallic materials may be achieved by adjusting the charge parameters such that a first material is deposited with a first charge characteristic and a second material is deposited with a second charge characteristic. This layer concept can help achieve an engineered construction for the shell mold such that exhibits intended characteristics for a thin-walled mold as provided herein. Furthermore, it is contemplated that a nano-laminated material may be formed through the coating processes provided herein.

Another coating technique that may be implemented includes spraying. A material to form the shell mold may be applied to one or more surfaces of the shell mold by dispersal from a nozzle. The dispersal of the material may be gas propelled (e.g., compressed air) or fluid propelled. A variety of materials having different characteristics may be applied in different layers at different location with spraying.

Another coating technique that may be implemented includes a dipping process. In the dipping process it is contemplated that the positive mold article is submerged or at least introduced into a collection of a material to coat the positive mold article. A variety of dipping stations containing the material(s) to form the shell mold may be used in different orders to build up the shell mold. As a partial submersion of the positive mold article can accomplish a coating in specific location, mold-forming material may be selectively applied.

The mold-forming material may be any material. In an exemplary aspect the mold-forming material is a metallic-based material, a ceramic-based material, or a polymer-based material. When a material is indicated as being “based,” it is intended to mean the material is comprised at least of the listed material. For example, a metallic-based material may be a composition of metallic and non-metallic materials, but it does at least include a metallic material. It is understood to a variety of materials may be used in any combination to form the shell mold. For example, as indicated above, an engineered structure may be formed through the coating process to apply nano- or micro-layers of mater in varied compositions to achieve a specified characteristic while still achieving a thin-walled shell mold.

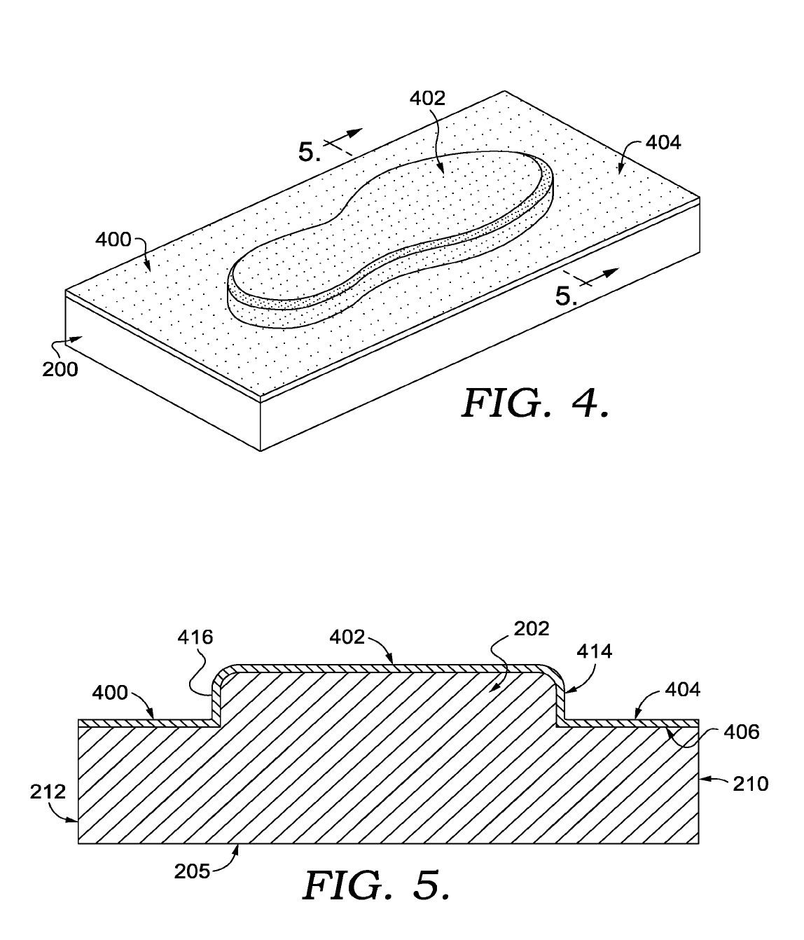

The coating process may only occur on a portion of the positive mold article and not the entirety of the positive mold article. As will be discussed in connection with FIGS. 4 and 5 hereinafter, a top surface of the positive mold article having an object representation thereon may be coated while a bottom surface of the positive mold article is not coated. This can aid in producing the flange portion. This can also aid in reducing the shell mold weight, cost, and production time.

Prior to coating the positive mold article, it is contemplated that a release agent may be applied to the surface(s) to which the shell mold will be formed. The release agent reduces an adhesive attraction between the shell mold and the positive tool mold. This release agent may be applied by dipping, spraying, brushing, dusting, and the like.

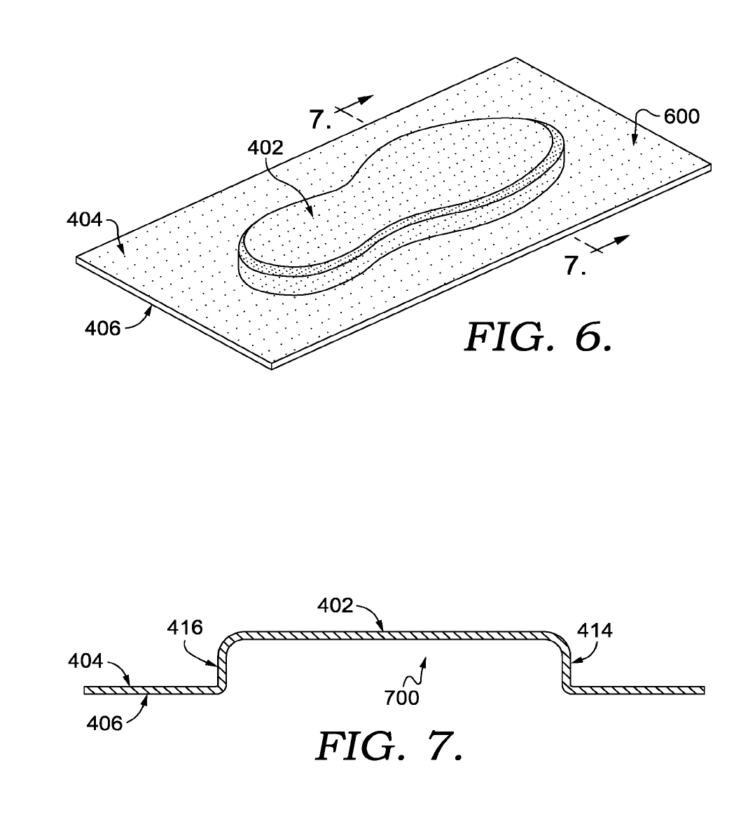

At a block 106, the shell mold is detached from the positive mold article. The detachment, which is depicted in FIGS. 6 and 7 hereinafter, separates the shell mold from the positive mold article. In an exemplary aspect the positive mold article can be sacrificial in a manner such that when exposed to a trigger (e.g., energy, chemical), the positive mold article decomposes or otherwise changes form to detach from the remaining shell mold. Additionally or alternatively, a physical separation between the shell mold and the positive mold article may be achieved through prying or other mechanical separations.

As the shell mold surface facing the positive mold article becomes a molding surface of the mold, the detachment should limit damaging the molding surface at least in proximity to the mold cavity formed by the object representation.

At a block 108, the shell mold is joined with a mold base. The mold base may be a standardized component that is capable of receiving a variety of shell molds. As such, a fewer number of mold bases may be maintained in inventory than if a specific mold base was used for a specific shell mold. The universal nature of the mold base can introduce cost saving, uniformity in tooling, and predictability into a manufacturing process. The mold base may be formed from any material. For example, the mold base may be formed from a metallic- or polymer-based material, in exemplary aspects.

The mold base may be formed from a material having a lower thermal conductivity than the shell mold material. Alternatively, the mold base may be formed from a material having a greater thermal conductivity than the shell mold material. This difference in thermal conductivity between the shell mold and the mold base can aid in the molding process such that an isolation of thermal energy between the two components can be achieved to increase manufacturing times. For example, the mold base may be more insulative than the shell mold such that an internal heating element to the internal volume of the mold base communicates thermal energy to the shell mold more effectively than the mold base, which allows for a more efficient thermal manipulation of the shell mold.

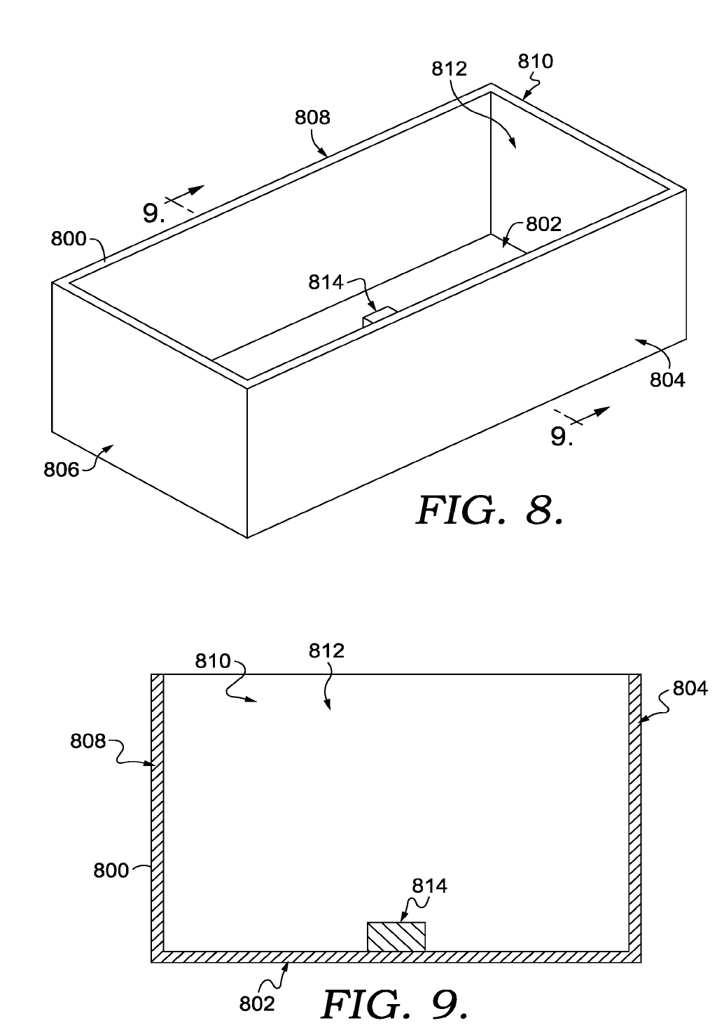

The mold base, as exemplarily depicted in FIGS. 8 and 9 hereinafter, may form a container-like structure to which the shell mold is joined to form an internal volume. The mold base has a bottom surface and a plurality of sides extending, such in a perpendicular manner, from the bottom surface. The mold base may also be comprised of a heating element to generate thermal energy, such as through a resistive element that generates heat in response to an electrical current passing there through.

The joining of the shell mold with the mold base may be in a permanent or temporary manner. For example, one or more fasteners (e.g., screws, clamps) may be used to align and/or secure the shell mold to the side surfaces (e.g., walls). Alternatively, an adhesive, hook-n-look, or other bonding solution may join the shell mold and the mold base. In an exemplary aspect, it is contemplated that the shell mold and/or the mold base include one or more physical alignment elements (e.g., pins, apertures, tabs) to ensure an alignment is achieved during the joining process.

Further, it is contemplated that the internal volume of the mold base and the shell mold when joined is filled, at least in part, with a material. The material, in an exemplary aspect, provides physical support to the shell mold. The material may be a non-compressible or substantially non-compressible material. For example, the material may be a powder, grit, pellet, or the like. Examples may include an aluminum-based material, such as a powder having aluminum elements in a composition. The mold base may have one or more opening through which the fill material may be introduced to the mold base after joining with the shell mold. The opening may be on a side surface or a bottom surface. Both of these surfaces can allow for a maximum filling volume that provides physical support to the shell mold when the fill material contacts the shell mold non-molding surface and the mold base.

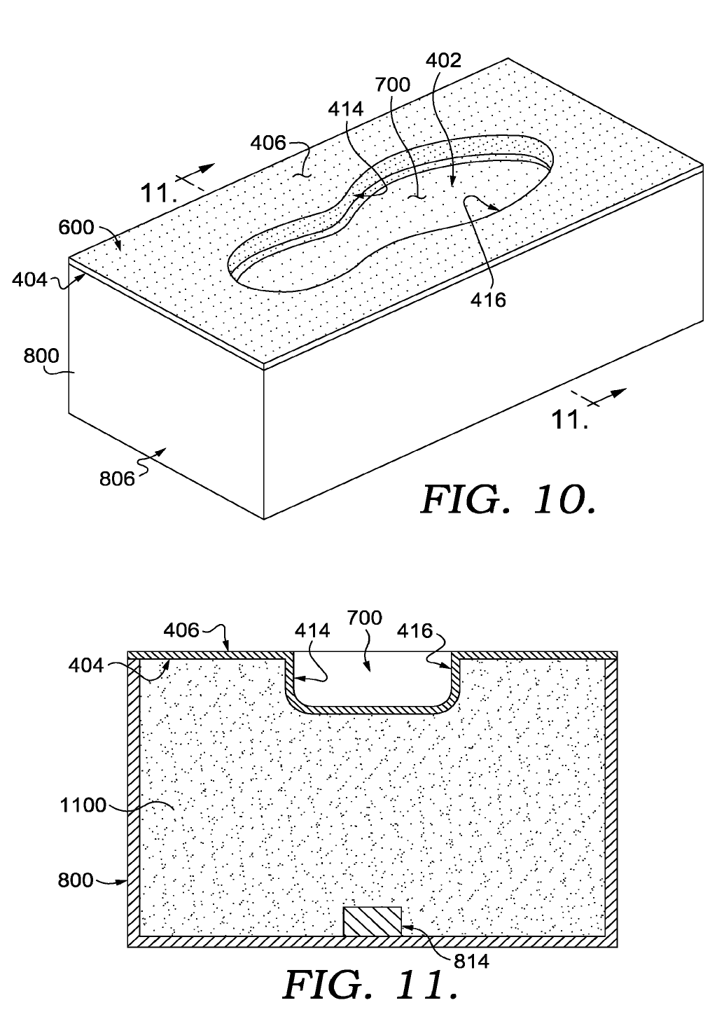

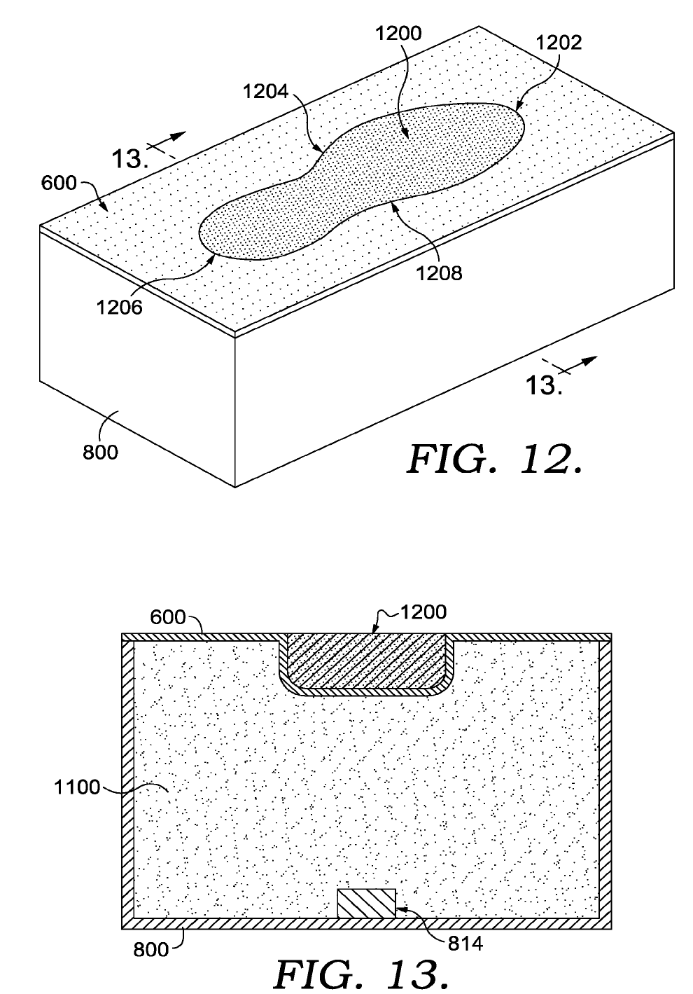

The method of represented by FIG. 1 is depicted in a following sequence of FIGS. 2-13. For example, FIGS. 2 and 3 depict an exemplary positive mold article as formed. FIGS. 4 and 5 depicted a coating on the positive mold article. FIGS. 6 and 7 depict an exemplary shell mold formed from the coating on the positive mold article. FIGS. 8 and 9 depict an exemplary mold base. FIGS. 10-11 depict the exemplary mold base having the shell mold attached thereon with a fill material within the internal cavity. FIGS. 12 and 13 depict a component, such as a shoe sole, molded within the mold cavity of the shell mold.

FIG. 2 depicts an exemplary positive mold article 200, in accordance with aspects hereof. The positive mold article 200 is comprised of a top surface having a component representation 202 and a flange 204. The positive mold article also has a first side 206, an opposite second side 208, a third side 210, and an opposite fourth side 212. Additionally, the positive mold article 200 is comprised of a bottom surface 205 that is opposite the top surface.

The component representation 202, as provided earlier, may be any positive representation of an article to be molded. In this non-limiting example an article of footwear sole portion (e.g., midsole, outsole) is depicted. The sole is comprised of a toe end forming a bulbous portion and an opposite heel end having a rounded end. The sole is also comprised of a medial and lateral side extending between the toe end and the heel end.

The positive mold article may be formed from any material, such as a polymer-based material, a metallic, based material, an organic-based material (e.g., cellulose fiber) and the like. The positive mold article, as previously discussed, may be formed from any technique. For example, an additive manufacturing technique may allow for the rapid production of the positive mold article.

FIG. 3 depicts a cross sectional view of the positive mold article along cut line 3-3 of FIG. 2, in accordance with aspects hereof. Side surfaces of the component representation 202 depicted as side surface 216 and 214. These side surfaces 214, 216 will eventually define sidewalls of a mold cavity formed in a shell mold. In this specific example, the side surfaces 214, 216 represent medial and lateral side representations for a molded sole.

FIG. 4 depicts the positive mold article 200 of FIG. 2 with a coating applied thereon to form a shell mold 400, in accordance with aspects hereof. As previously discussed, the mold-forming material that is applied to coat the positive mold article may be any material, such as a metallic-based material, a polymer-based material, or a ceramic-based material. The mold-forming material may be applied by any technique, such as electrodeposition, spraying, dipping, or the like. The shell mold 400 is comprised of an object representation mold 402 and a flange 404. The prominent surface exposed in FIG. 4 and facing away from the positive mold article is a non-molding surface for the shell mold 400. As will be depicted in FIG. 10 hereinafter, the shell mold will be flipped to expose the opposite surface having the mold cavity formed around the component representation 202 of FIG. 2.

FIG. 5 depicts a cross sectional view of the positive mold article 200 and the shell mold 400 along cut line 5-5 of FIG. 4, in accordance with aspects hereof. As depicted in FIG. 5, the object representation mold 402 includes sidewalls 414, 416. The sidewalls 414, 416 correspond with the side surfaces 214, 216 of the positive mold article and capture surface details thereof. Also depicted is a molding surface 406. The molding surface 406 is facing the positive mold article. The molding surface 406 will form, in an exemplary aspect, a surface onto which a mold material may be applied and formed into the object represented by the component representation 202 of the positive mold article.

FIG. 6 depicts the shell mold of FIG. 4 detached from the mold base, in accordance with aspects hereof. The shell mold depicts a non-molding surface from which the object representation mold 402 extends and the molding surface 406.

FIG. 7 depicts a cross sectional view of the shell mold along cut line 7-7 of FIG. 6, in accordance with aspects hereof. While the shell mold in FIG. 7 is depicted as being formed from a homogenous material in the cross section, it is only for illustrative purposes depicted as such. To the contrary, it is contemplated that the shell mold may be formed from a plurality of layers having different material compositions and/or structures. A mold cavity 700 is depicted as extending between the sidewalls 414, 416 within the object representation mold 402.

FIG. 8 depicts a mold base 800, in accordance with aspects hereof. The mold base 800 is comprised of a bottom surface 802, a plurality of sides 804, 806, 808, 810, and a heating element 814, in this exemplary aspect. It is appreciated that the mold base implemented may be any size, shape, or configuration. Further, it is contemplated that the heating element 814 may be omitted altogether in some aspects. The mold base 800 may be formed from any material, such as a polymer-based material having better thermal insulative characteristics (less thermal conductivity) than a material forming the shell mold. The mold base may be universal in nature and allow for a variety of shell molds to be attached thereto. In alternative shell mold examples, a flange size may be adjusted to compensate for the object representation to change in size/shape. The flange may be the joining portion to the side surfaces of the mold base.

FIG. 9 depicts a cross sectional view of the mold base 800 along cut line 9-9 of FIG. 8, in accordance with aspects hereof. As depicted, an internal volume 812 is formed between the bottom surface 802 and the plurality of sides 804, 806, 808, and 810. The internal volume may be encased with the shell mold to form an enclosed volume capable of maintaining a fill material. By having the internal volume enclosed, the fill material can provide physical support to the shell mold during a molding operation.

FIGS. 8 and 9 do not depict a fill aperture for introducing a fill material into the internal cavity, but it is understood that one or more sealable opening may extend through the one or more of the bottom surface 802 or one or more of the plurality of sides 804, 806, 808, 810. Additionally, while not depicted, it is contemplated that one or more wires may extend through the mold base. The wires (or other communication materials) may provide energy for the heating element 814 and support instrumentation (e.g., temperature probe). If such a wire does pass through the mold base, it is contemplated that it is sealed sufficient to maintain a fill material within the internal volume in an exemplary aspect.

FIG. 10 depicts the shell mold 400 of FIG. 4 joined with the mold base 800 of FIG. 8, in accordance with aspects hereof. The shell mold 400 is flipped from previously illustrated perspectives allowing the molding surface 406 to be prominent and placing the non-molding surface proximate (e.g., contacting or close to contacting) the mold base 800. This orientation presents the mold cavity 700 for use in a molding operation, such as a cast molding operation.

FIG. 11 depicts a cross sectional view of the mold base 800 joined with the shell mold along cut line 11-11 of FIG. 10, in accordance with aspects hereof. As depicted, the internal volume formed by the mold base 800 and the shell mold 400 is filled with a fill material such that the fill material is contacting at least the surfaces forming the mold cavity 700. This contact may be effective to provide physical support to a thin-walled shell mold and/or this contact may be effective to thermally conduct to/from the shell mold. The thermal conductivity may be useful for transmitting heat from the heating element 814 and/or for extracting heat from the mold cavity 700 to increase a cure tie f an article molded therein.

FIG. 12 depicts a mold formed with the mold base and the joined shell mold of FIG. 10 with a molded component 1200 formed in the mold cavity, in accordance with aspects hereof. As provided any object may be molded with the mold contemplated herein, but for illustrative purposes a sole-like article is provided. The molded component 1200, in this example, is formed with a toe end 1202, a heel end 1206, a medial side 1208, and a lateral side 1204. However, any size, shape, and configuration of a component may be formed with the mold provided herein.

FIG. 13 depicts a cross sectional view of the mold along cut line 13-13 of FIG. 12, in accordance with aspects hereof. While the molded component 1200 is depicted as being formed from a homogenous material for illustrative purposes, it is contemplated that the molded component 1200 may be a multi-material component. For example, multiple layers may be co-molded to form the molded component 1200, in an exemplary aspect.

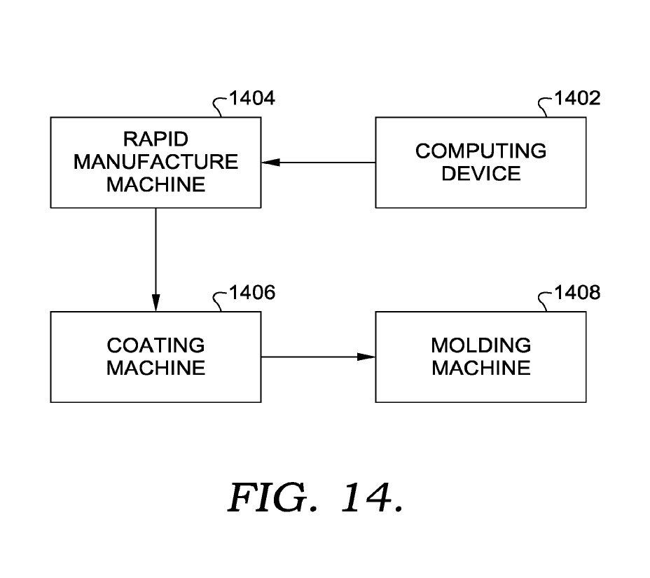

FIG. 14 depicts a system for forming a mold and using the mold to mold a component, in accordance with aspects hereof. While specific machines/devices are listed, it is understood that one or more may be omitted or added. Further it is contemplated that alternative machines/devices may be implemented in conjunction with or substitute for those machines/devices listed. A computing device 1402 is provided. The computing device 1402 may be effective to generate one or more digital files useful for instruction a rapid manufacturing machine 1404 to generate a positive mold article. The computing device 1402 has a processor and memory that can take user inputs to generate a digital model useable by the rapid manufacturing machine 1404 to form an article.

The rapid manufacture machine 1404 may be an additive manufacturing machine or a subtractive manufacturing machine. Examples of techniques that may be used by the rapid manufacture machine 1404 include, but are not limited to, fused deposition modeling, fused filament fabrication, direct ink writing, stereo lithography, digital light processing, powdered bed printing, electron beam melting, selective laser melting, selective heat sintering, selective laser sintering, direct metal laser sintering, laminated object manufacturing, and electron beam freeform fabrication, and the like.

A coating machine 1406 applies a coating of mold-forming material to the positive mold article formed from the rapid manufacture machine 1404. The coating machine may use a variety of techniques to apply the coating. For example, the coating may be dipped, sprayed, or electrodeposited, for example. Additional coating technologies are contemplated as well. The coating machine 1406 may be effective to apply multiple layers to form a micro- or nano-laminated structure. The coating may be polymer-based, metallic-based, or ceramic-based, in exemplary aspects. Additional coating materials are contemplated.

A molding machine 1408 molds an object in the formed shell mold from the coating machine 1406. Any molding technique may be used, such as cast molding. The molding machine may be effective to deposit a molding material, such as a polymer-based material, within a mold cavity of the shell mold. Examples of molding material include, but are not limited to polyurethane, thermoplastic polyurethane ethyl-vinyl acetate, and other thermoplastic polymers. Further, it is contemplated that metallic materials may be used, ceramic material may be used, and the like.

While specific configurations and orientations are depicted in the figures provided, they are illustrative in nature and not limiting.

From the foregoing, it will be seen that this invention is one well adapted to attain all the ends and objects hereinabove set forth together with other advantages which are obvious and which are inherent to the structure.

It will be understood that certain features and subcombinations are of utility and may be employed without reference to other features and subcombinations. This is contemplated by and is within the scope of the claims.

While specific elements and steps are discussed in connection to one another, it is understood that any element and/or steps provided herein is contemplated as being combinable with any other elements and/or steps regardless of explicit provision of the same while still being within the scope provided herein. Since many possible embodiments may be made of the disclosure without departing from the scope thereof, it is to be understood that all matter herein set forth or shown in the accompanying drawings is to be interpreted as illustrative and not in a limiting sense.

the invention claimed is:

1. A method of forming a mold, the method comprising:
forming a positive mold article;
coating at least a portion of the positive mold article with a mold-forming material to form a shell mold, wherein the shell mold is comprised of a molding surface adjacent the positive mold article and a non-molding surface nonadjacent the positive mold article;
detaching the shell mold from the positive mold article; and
joining the shell mold with a mold base, wherein an internal volume is formed between the non-molding surface and the mold base.

2. The method of claim 1, wherein forming the positive mold article includes forming the positive mold article with an additive manufacturing technique.

3. The method of claim 1, wherein forming the positive mold article includes forming the positive mold article with a subtractive manufacturing technique.

4. The method of claim 1, wherein the mold-forming material is at least one material selected from the following: metallic-based material, ceramic-based material, or polymer-based material.

5. The method of claim 1, wherein the coating of at least a portion of the positive mold article comprises an electrodeposition process, a dipping process, or a spraying process.

6. The method of claim 1 further comprising applying an electrically conductive material to the positive mold article prior to coating at least a portion of the positive mold article.

7. The method of claim 1, wherein coating at least a portion of the positive mold article comprises depositing multiple overlapping layers of the mold-forming material on the positive mold article.

8. The method of claim 7, wherein the mold-forming material is a first material at a first layer and a different second material at a second layer.

9. The method of claim 1, wherein the shell mold has a thickness between the molding surface and the non-molding surface that is less than 1 centimeter.

10. The method of claim 1, wherein the shell mold has a thickness between the molding surface and the non-molding surface is between 5 millimeters and 0.5 millimeters.

11. The method of claim 1, wherein the mold base is comprised of a heating element effective to generate thermal energy.

12. The method of claim 1, wherein the mold base is formed with a base bottom and a plurality of sides extending from the base bottom, wherein the base bottom, the plurality of sides, and the shell mold defining the internal volume.

13. The method of claim 1, further comprising filling the internal volume with a non-compressible powder that is a thermally conductive material.

14. The method of claim 13, wherein the non-compressible powder is comprised of an aluminum-based material.

15. The method of claim 1 further comprising heating the shell mold subsequent to joining the shell mold and the mold base.

16. A mold, the mold comprising:
a mold base having a bottom surface and a plurality of side surfaces extending from the bottom surface; and
a shell mold having a molding surface and an opposite non-molding surface, wherein the shell mold has a thickness between the molding surface and the non-molding surface within a range of 20 millimeters to 0.5 millimeters,
the shell mold coupled with the mold base proximate the mold base side surfaces, wherein the shell mold and the mold base define an internal volume between the mold base bottom surface, mold base side surfaces, and the shell mold non-molding surface.

17. The mold of claim 16, wherein the mold base is formed from a first material and the shell mold is formed from a second material.

18. The mold of claim 16, wherein the first material is less thermally conductive than the second material.

19. The mold of claim 16, wherein the shell mold is formed from a plurality of layers, wherein a first layer of the plurality of layers is a different material composition than a second layer of the plurality of layers

20. The mold of claim 216, wherein the internal volume is comprised of a non-compressible material.
